(19) United States
(12) Patent Application Publication
(10) Pub. No.: US 2021/0010849 A1
(43) Pub. Date: Jan. 14, 2021

(54) POWDER MASS MEASUREMENTS IN CONTAINERS

(71) Applicant: Hewlett-Packard Development Company, L.P., Spring, TX (US)

(72) Inventors: Alexander David LAWS, Vancouver, WA (US); Bradley Alan BENSON, Corvallis, OR (US); Joshua Ryan SCHMALE, Vancouver, WA (US); Leon Johannes Arnoldus BRUNKEN, Vancouver, WA (US); Justin Michael ROMAN, Vancouver, WA (US); Lukas Peter SOSNOWSKI, Vancouver, WA (US)

(21) Appl. No.: 16/505,490

(22) Filed: Jul. 8, 2019

(51) Int. Cl. G01G 5/00; B29C 64/255; B33Y 30/00; G01G 17/04

(52) U.S. Cl. CPC G01G 5/006; G01G 17/04; B33Y 30/00; B29C 64/255

(57) ABSTRACT

An example of an apparatus is provided. The apparatus includes a container to store a powder. The apparatus includes a flow generator to move a gas to the container. The flow generator is to move the gas at a first velocity and a second velocity, the first velocity to fluidize the powder in a fluidized state, and the second velocity to pass through stationary powder in a powder pack. The apparatus includes pressure sensors to measure pressures in the container. The apparatus includes a measurement engine in communication with the pressure sensors, wherein the measurement engine is to calculate a mass of the powder based on a fluidized pressure differential and based on a pack pressure differential.

### BACKGROUND

Printing devices are often used to present information. In particular, printing devices may be used to generate output, such as documents in the case of standard printing devices, or three-dimensional objects in the case of a three-dimensional printing device, that may be easily handled and viewed or read by users. Accordingly, the generation of output from printing devices from electronic form continue to be used for the presentation and handling of information. Some printing devices recycle build materials that may not be used during portions of the build process. Accordingly, build materials are to be collected and transported throughout the printing device. To transport build materials throughout the printing device, build material transport paths may be used where build materials may be carried through conduits using a gas flow.

### BRIEF DESCRIPTION OF THE DRAWINGS

Reference will now be made, by way of example only, to the accompanying drawings in which:

FIG. 1 is a schematic representation of an example apparatus to measure the mass of powder in a container;

FIG. 2 is a schematic representation of another example apparatus to measure the mass of powder in a container;

FIG. 3 is a schematic representation of an example controller to receive signals from pressure sensors in a container;

FIG. 4 is a schematic representation of another example apparatus to measure the mass of powder in a container; and

FIG. 5 is a flowchart of an example of a method of measuring the mass of powder in a container.

### DETAILED DESCRIPTION

Three-dimensional (3D) printing may produce a 3D object by adding successive layers of build material, such as powder, to a build platform, then selectively solidifying portions of each layer under computer control to produce the 3D object. The build material may be powder, or powder-like material, including metal, plastic, ceramic, composite material, and other powders. In some examples the build material may be formed from, or may include, short fibers that may, for example, have been cut into short lengths from long strands or threads of material. The objects formed may be various shapes and geometries, and may be produced using a model, such as a 3D model or other electronic data source. The fabrication may involve laser melting, laser sintering, heat sintering, electron beam melting, thermal fusion, and so on. The model and automated control may facilitate the layered manufacturing and additive fabrication. The 3D printed objects may be prototypes, intermediate parts and assemblies, as well as end-use products. Product applications may include aerospace parts, machine parts, medical devices, automobile parts, fashion products, and other applications. Some printing devices use powders to generate output. In such printing devices, pneumatic build material delivery systems may be used to deliver a powder from one part of the printing device, such as a storage container to a hopper or spreading device that forms a layer of build material that is to be processed. Large printing devices may have large and complex delivery systems for various build materials.

The build material may be, for example, a dry, or substantially dry, powder. In a three-dimensional printing example, the build material may have an average volume-based cross-sectional particle diameter size between about 5 and about 400 microns, between about 10 and about 200 microns, between about 15 and about 120 microns or between about 20 and about 70 microns. Other examples of suitable, average volume-based particle diameter ranges include about 5 to about 70 microns, or about 5 to about 35 microns. As used herein, a volume-based particle size is the size of a sphere that has the same volume as the powder particle. The average particle size is intended to indicate that most of the volume-based particle sizes in the container are of the mentioned size or size range. However, the build material may include particles of diameters outside of the mentioned range. For example, the particle sizes may be chosen to facilitate the distribution of build material layers having thicknesses of between about 10 and about 500 microns, or between about 10 and about 200 microns, or between about 15 and about 150 microns. One example of a manufacturing system may be pre-set to distribute powdered material layers of about 80 microns using build material containers that include build material having average volume-based particle diameters of between about 40 and about 60 microns. An additive manufacturing apparatus may also be configured or controlled to form powder layers having different layer thicknesses.

As described herein, the build material may be, for example, a semi-crystalline thermoplastic material, a metal material, a plastic material, a composite material, a ceramic material, a glass material, a resin material, or a polymer material, among other types of build material. Further, the build material may include multi-layer structures wherein each particle comprises multiple layers. In some examples, a center of a build material particle may be a glass bead, having an outer layer comprising a plastic binder to agglomerate with other particles for forming the structure. Other materials, such as fibers, may be included to provide different properties, for example, strength.

During the build process, build material, such as powder, may be used. Furthermore, the build process is generally to be completed to various stages without interruption. Accordingly, prior to beginning the build process, the mass of powder stored in the source container, such as a hopper, may be measured to determine if there is sufficient powder for a specific build process. The manner by which the amount of powder is to be measured is not limited. For example, if there is sufficient space within a container to fluidize the powder, a measurement may be made to determine the mass of the powder based on a density and a known volume. By carrying out the measurement in the fluidized state, it is to be appreciated that the density of the mixture may be measured directly based on a pressure reading at a location and the known cross sectional area of the container.

As another example, a packed bed method may be used in situations where there is not sufficient space to carry out the fluidization of the powder. In the packed bed method, measurements may be made to extrapolate the height of the powder in the container from which a mass may be estimated if the density is known.

Since the best method to estimate the mass of powder in the source container is not always the same, an apparatus that may use multiple methods of powder mass measurement is provided. The apparatus may attempt to measure the mass using both methods and/or may determine the more accurate method to report. In some examples, the apparatus may also select the more accurate method based on preliminary measurements or other preliminary indicators, which may include a user selection.

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown

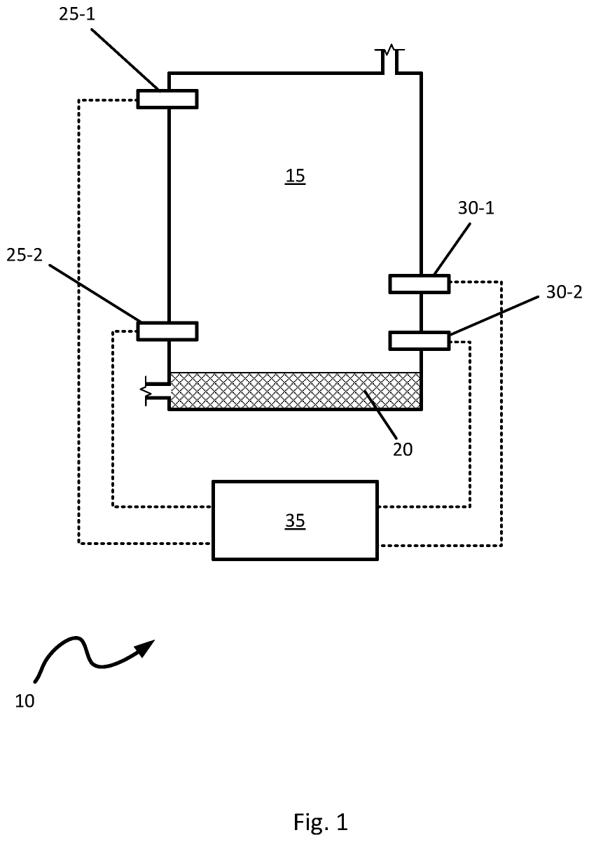

Referring to FIG. 1, an apparatus to measure the mass of powder in a container is shown at 10. The apparatus 10 may be a part of the printing device or a separate component to operate on the printing device to estimate the amount of powder in a hopper of the printing device. Accordingly, for printing devices where powder is separated into different types, a separate apparatus 10 may be used for each type of powder. The apparatus 10 may also include additional components, such as various additional interfaces and/or displays to interact with a user or administrator of the apparatus, such as to monitor and control various components of the printing device. In the specific example, the apparatus 10 is to use multiple methods to estimate the amount of powder in a container. In the present example, the apparatus 10 includes a container 15, a flow generator 20, fluidized pressure sensors 25-1 and 25-2, pack pressure sensors 30-1 and 30-2, and a measurement engine 35.

The container 15 is to store a powder or other build material for a build process. The container 15 is not particularly limited and may include any device capable of storing a powder or other build material. In the present example, the container 15 is a hopper having a gas inlet at the bottom to receive a gas. The container 15 may also include various ports such as a port for receiving new powder or other build material and/or a port for removing the powder or other build material and transporting the powder or other build material toward a build chamber via a build material transport system (not shown). The type of powder or other build material received in the container 15 is also not particularly limited. For example, the container 15 may receive a new supply of powder. In this example, a known amount of powder from an external source may be added to the container 15. In another example, the container 15 may receive recycled powder. It is to be appreciated that some of the powder transported to a build chamber for a build process may not be used in the formation of the object and instead be excess powder. The excess powder may be collected and eventually transported into the container 15 for re-use in another build process. In another example, the container 15 may be part of a media recovery system where the container is to store powder directly recovered from the build chamber that may have been trapped in a filter (not shown) of a vacuum source of the build material transport system.

The flow generator 20 is to move a gas into the container 15. In the present example, the gas is air from the ambient atmosphere. In other examples, another gas may be substituted, such as nitrogen, carbon dioxide, an inert gas, a humidified gas, or a mixture of different gases. The manner by which the flow generator 20 moves the gas is not limited. For example, the flow generator 20 may receive the gas from a pump (not shown) and introduce the gas into the container 15 evenly across the bottom such that the gas flows through the powder in the container 15 toward an outlet, such as a vent with a filter or into a build material transport system. In other examples, the flow generator 20 may be a fluidizer plate to allow the gas to enter into the container 15 as vacuum source connected to the container 15 draws the gas in via the flow generator 20. In another example, the flow generator 20 may recycle the gas in the container to move the powder such that no gas is introduced into the container 15.

The flow generator 20 provides for gas to be moved to the container at different velocities. For example, the flow generator 20 may move the gas at a velocity to fluidize the powder in the container 15 to provide a fluidized state. The fluidized state means that the powder and gas mixture in the container 15 is to behave as fluid. It is to be appreciated that in order to achieve full fluidization, the container 15 is to have sufficient volume for the powder to mix with the gas in a fluid manner. Accordingly, in the present example the container 15 may have a volume of about 25 liters to about 40 liters depending on the use for the hopper. However, in other examples, the volume may be greater or smaller for other printing systems. In addition, the flow generator 20 may move gas at another velocity where the gas is to pass through the powder in a powder pack state. In this state, the velocity of the gas is sufficiently low such that the gas does not disturb the stationary powder in the powder pack.

In the present example, the flow generator 20 may control the velocity of the gas entering the container 15. For example, the flow generator 20 may include a valve or regulator to control the flow of gas within the container 15. In other examples, it is to be appreciated that the flow generator 20 may be a passive component and that the velocity of the gas may be controlled by external components such as a pump or via other valves or regulators.

The fluidized pressure sensors 25-1 and 25-2 (generically, these fluidized pressure sensors are referred to herein as “fluidized pressure sensor 25”, and collectively they are referred to as “fluidized pressure sensors 25”, this nomenclature is used elsewhere in this description) are to measure a pressure within the container 15. The fluidized pressure sensors 25 are not particularly limited and may be any sensor capable of measuring the pressure within the container 15. For example, the fluidized pressure sensors 25 may include a diaphragm and a mechanism to measure the force applied to the diaphragm by the gas inside the container 15. In the present example, the fluidized pressure sensors 25 are positioned at different heights within the container 15. In particular, the fluidized pressure sensor 25-1 is positioned substantially near the top of the container 15 and the fluidized pressure sensor 25-2 is positioned substantially near the bottom of the container 15. Accordingly, the fluidized pressure sensor 25-1 is positioned above the powder in the container 15. By contrast, the pressure sensor 25-2 is positioned with the fluidized powder. In other examples, the fluidized pressure sensors 25 may be positioned closer to each other as long as the fluidized pressure sensor 25-1 is not in the fluidized powder.

The pack pressure sensors 30-1 and 30-2 are also to measure a pressure within the container 15 as gas is passed through the powder pack by the flow generator 20. The pack pressure sensors 30 are not particularly limited and may be any sensor capable of measuring the pressure within the container 15. For example, the pack pressure sensors 30 may include a diaphragm and a mechanism to measure the force applied to the diaphragm by the gas inside the container 15. In the present example, the pack pressure sensors 30 are positioned at different heights within the container 15. In particular, the pack pressure sensor 30-1 is positioned above the pack pressure sensor 30-2, which is positioned substantially near the bottom of the container 15. In other examples, the pack pressure sensors 30 may be positioned closer to each other or further away. It is to be appreciated that the pack pressure sensors 30 are to measure pressure within the powder pack. Accordingly, as the powder in the container 15 is depleted during the build process, the height of the powder pack decreases. Placing the pack pressure sensor 30-1 too high may decrease the range of powder that may be measured because once the level drops below the height of the pack pressure sensor 30-1, the mass of powder in the container 15 cannot be estimated using the packed bed method. However, it is to be appreciated that once the powder in the container 15 decreases to a sufficiently low level, a measurement may be made using the fluidized state.

In the present example, the fluidized pressure sensors 25 and the pack pressure sensors 30 are each separate sensors. As discussed above, the fluidized pressure sensors 25 are to be used when the powder is in a fluidized state which inherently is a higher pressure than when the powder is in a powder pack state. Accordingly, the fluidized pressure sensors 25 and the pack pressure sensors 30 may be different types of pressure sensors where each is selected based on the expected pressure range during operation. It is to be appreciated that in some examples, the fluidized pressure sensors 25 and the pack pressure sensors 30 may be combined.

In the present example, the measurement engine 35 is in communication with the fluidized pressure sensors 25 and the pack pressure sensors 30. The measurement engine 35 may include a central processing unit (CPU), a microcontroller, a microprocessor, a processing core, a field-programmable gate array (FPGA), an application-specific integrated circuit (ASIC), or similar. The measurement engine 35 may include a memory storage unit to store various instructions for execution. In particular, the measurement engine 35 may execute instructions stored on the memory storage unit to carry out various functions and to estimate the mass of powder in the container 15. For example, the measurement engine 35 may be used to implement an ongoing monitoring process throughout the build process to generate an alert or take other corrective measures if there is insufficient powder in the container 15 to complete the job.

In the present example, the measurement engine 35 is to receive signal from the fluidized pressure sensors 25 and the pack pressure sensors 30. The signals received from the fluidized pressure sensors 25 and the pack pressure sensors 30 are not particularly limited. In the present example, the signals may include raw data measured by each of the fluidized pressure sensors 25 and the pack pressure sensors 30. In the present example, the raw data may be a reading that may be convertible to a pressure by the measurement engine 35. In other examples. the data received by the measurement engine from the fluidized pressure sensors 25 and the pack pressure sensors 30 may have been converted to a pressure value at the fluidized pressure sensors 25 and the pack pressure sensors 30. Continuing with this example, the measurement engine 35 then analyzes the raw data to calculate a mass of the powder using a fluidized state calculation and/or a packed bed calculation.

In the fluidized state calculation, the measurement engine 35 is to use the data from the fluidized pressure sensors 25 to determine a fluidized gauge pressure at a height in the container 15. Accordingly, the fluidized pressure sensor 25-1 is to measure the background pressure in the absence of the fluidized powder while the fluidized pressure sensor 25-2 measures a pressure at the height. The fluidized gauge pressure is based on the difference measured in the fluidized powder compared with the pressure above the powder. It is to be appreciated that the pressure during full fluidization decreases at higher heights in the container 15. In particular, the weight of the powder (i.e. the gravitational force applied by the powder) above the fluidized pressure sensor 25-2 is the fluidized pressure differential between the two fluidized pressure sensors 25. Accordingly, this weight of the powder can then be converted to a mass of powder between the fluidized pressure sensors 25 provided that cross sectional area of the container 15 is known. In the present example, the density of the powder may be assumed to be substantially uniform on average within the container 15 above and below the fluidized pressure sensors 25. Therefore, the mass of powder in between the fluidized pressure sensors 25 may be used to calculate the total mass in the container 15 by extrapolating the volume between the fluidized pressure sensors 25 to the volume of the container. In other examples, a different density may be used for the bottom portion or the top portion. These density values may be assumed based on empirical data or calculations.

In the packed bed calculation, the measurement engine 35 is to use the data from the pack pressure sensors 30 to determine a pack pressure differential between two different heights in the container 15. It is to be appreciated that as the gas passes from the flow generator 20 to the top of the powder pack, the pressure decreases in a linear manner. Furthermore, in the packed bed state, the gauge pressure at the top surface of the powder pack is to be zero such that the powder pack is not lifted by the passage of the gas and each particle of the powder is static. If the gauge pressure is greater than zero, the gas may move with sufficient velocity to lift the particles at the surface to aerate the powder. Accordingly, by measuring the pressure at different heights, the height of the powder pack may be extrapolated assuming the linear decrease in pressure to zero at the surface. Once the height of the powder pack is determined, the mass may be calculated based on the cross sectional area of the container 15 and the known density of the powder pack. Since the height of the powder pack is determined, it is to be appreciated that the powder pack is to be substantially level during the measurements of the pack pressure differential. Accordingly, various leveling procedures such as an aeration burst or vibration method may be used to level the powder pack.

The two calculation methods provide alternative ways to estimate the amount of powder in the container 15. In the present example, both calculation methods are performed when possible such that the two calculations methods may be compared to each other. Alternatively, one method may be used over the other depending on the circumstances. For example, if the powder pack is below the height of the pack pressure sensor 30-1, the packed bed calculation method is not available since the pack pressure sensor 30-1 may register zero gauge pressure. Accordingly, in this situation, the apparatus 10 will use the fluidized state calculation only. Alternatively, if the container 15 has too much powder to achieve the fluidized state, the apparatus 10 will use the packed bed calculation method only. It is to be appreciated that at least one of the two calculation methods are available for all ranges of powder from when the container 15 is substantially empty to when the container 15 is substantially full.

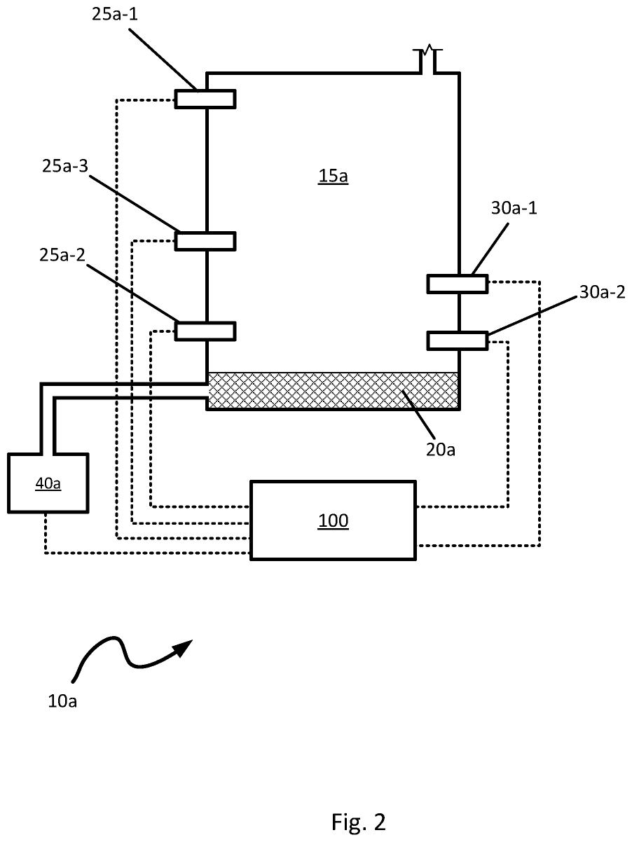

Referring to FIG. 2, another example of an apparatus to measure the mass of powder in a container is shown at 10a. Like components of the apparatus 10a bear like reference to their counterparts in the apparatus 10, except followed by the suffix “a”. The apparatus 10a may be a part of the printing device or a separate component to operate on the printing device to estimate the amount of powder in a hopper of the printing device. The apparatus 10a includes a container 15a, a flow generator 20a, fluidized pressure sensors 25a-1, 25a-2, and 25a-3, pack pressure sensors 30a-1 and 30a-2, a pump 40a, and a controller 100.

In the present example, the flow generator 20a is connected to a pump 40a to supply the gas into the container 15a. The pump 40a is not particularly limited and may include any mechanical device capable of moving gas or generating a positive pressure to supply to the flow generator 20a. For example, the pump 40a may take ambient air and inject it into the container 15a via the flow generator 20a. Furthermore, the pump 40a may be used to generate a fluidization burst of gas to the flow generator 20a. The flow generator 20a may provide the fluidization burst to generate a fluidized state within the container 15a for a temporary period of time. In this example, the container 15a may be normally in a packed bed state or an aerated state, which is between the packed bed state and the fluidized state, to conserve power. The flow generator 20a may then provide addition flow of gas into the container 15a to measure the fluidized pressures with the fluidized pressure sensors 25a for the purpose of calculating the mass of the powder in the container 15a.

In addition, the flow generator 20a may receive gas via the pump 40a to provide an aeration burst to bring the powder into an aerated state. A short aeration burst may be used to prepare the powder pack for a measurement using the packed bed calculation method. The aeration burst is not limited and may be the same strength and duration as the fluidization burst. However, it is to be appreciated that a lower velocity of gas is compared with the fluidization burst.

Furthermore, the present example includes the fluidized pressure sensors 25a. The additional fluid pressure sensor may be used to confirm that the fluidized state has been achieved during the fluidization burst. In particular, the mass between each of the fluidized pressure sensors 25a may be determined in accordance with the fluidized state calculation described above. Accordingly, a first mass may be calculated between the fluidized pressure sensors 25a-1 and 25a-2, and a second mass may be calculated between the fluidized pressure sensors 25a-1 and 25a-3. Based on the distance between each of the fluidized pressure sensors 25a-3 and 25a-2, the mass difference between the reading obtained from fluidized pressure sensors 25a-3 and 25a-2 is the mass in the volume bound by the fluidized pressure sensors 25a-3 and 25a-2 may be used to calculated and the density the volume since the cross sectional area is known and uniform in the present example.

Although the present example includes a fluidized pressure sensor 25a-1 above the powder and two fluidized pressure sensors 25a-3 and 25a-2 disposed in the powder, other examples may include additional pressure sensors. Therefore, the container 15 may be divided into multiple volumes where the density in the volume may be calculate. By measuring the density in multiple volumes, a verification step may be used to confirm that the powder is in a fluidized state. In particular, the fluidized state may then be confirmed if the densities measured in different volumes is within a predetermined threshold. For example, a fluidized state may be defined as having a density difference of less than about 0.02 g/cm³. In other examples, the threshold may be lower or higher.

In the present example, the controller 100 is in communication with the fluidized pressure sensors 25a, the pack pressure sensors 30a, and the pump 40a. The controller is to send and receive signals from various components of the apparatus 10a. For example, the controller may receive raw data from the fluidized pressure sensors 25a and the pack pressure sensors 30a to calculate the mass of powder in the container 15a. In addition, the controller 100 may be used to control the pump 40a to switch between the fluidized state and the packed bed state of the powder. It is to be appreciated that in some examples where the flow generator 20a controls the gas flow into the container 15a, the controller 100 may also be in communication with the flow generator 20a.

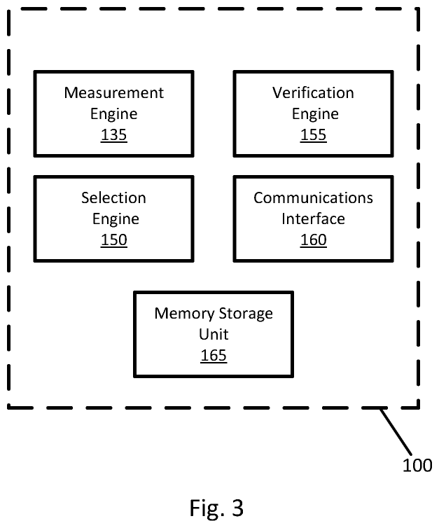

Referring to FIG. 3, the components of the controller 100 are shown in greater detail. It is to be appreciated that the controller 100 is not limited and may be part of the larger printing device. For example, the controller 100 may be a dedicated portion of the main processor of the printing device. In other examples, the controller 100 may be a stand alone unit added to the printing device. The controller includes a measurement engine 135, a selection engine 150, a verification engine 155, a communication interface 160, and a memory storage unit 165.

In the present example, the measurement engine 135 is to receive signal from the fluidized pressure sensors 25a and the pack pressure sensors 30a. The signals received from the fluidized pressure sensors 25a and the pack pressure sensors 30a are not particularly limited. In the present example, the signals may include raw data measured by each of the fluidized pressure sensors 25a and the pack pressure sensors 30a. The raw data may be a reading that may be convertible to a pressure by the measurement engine 135. In other examples. the data received by the measurement engine from the fluidized pressure sensors 25a and the pack pressure sensors 30a may have been converted to a pressure value at the fluidized pressure sensors 25a and the pack pressure sensors 30a. Continuing with this example, the measurement engine 135 then analyzes the raw data to calculate a mass of the powder using a fluidized state calculation and/or a packed bed calculation.

The selection engine 150 is to make a determination as to whether the mass in the container 15a is to be calculated using the fluidized state calculation or the packed bed calculation. The manner by which the selection engine 150 makes the determination is not particularly limited. For example, the determination may be made based on the volume of the container 15a, such as whether there is sufficient volume to fluidize the powder. In a situation where there is not sufficient volume to fluidize the powder, the selection engine 150 is to select using the packed bed calculation to measure the amount of powder in the container. Alternatively, in a situation where the pack pressure sensor 30a-1 is above the surface of the powder pack, the selection engine 150 is to select using the fluidized state calculation. In other situations, the selection engine 150 may select both calculation methods to compare the results.

The verification engine 155 is to verify the mass calculated by the measurement engine 135. The manner by which the verification is carried out is not particularly limited. For example, the verification engine 155 may use the results from the fluidized state calculation, where the measurement engine 135 uses raw data from the fluidized state, and a packed bed calculation, where the measurement engine 135 uses raw data measured from the pack pressure sensors 30a in the stationary powder. The values from the two calculation methods may then be compared with each other to determine if the difference is within a predetermined threshold. In other examples, the verification engine 155 may compare a calculated value using either the fluidized state calculation or the packed bed calculation with a known value, such as from a database, or a user entered value.

The communications interface 160 is to communicate with external devices. In particular, the communications interface 160 is to send commands and data to an external device, such as a remote server of client device, and to receive commands and data from the external device. For example, the communications interface 160 may be used to transmit data to a server, such as a print service, to alert an administrator that the powder level is low.

The manner by which the communication interface 160 sends and receives data is not particularly limited. In the present example, the communication interface 160 may be a wireless interface to communicate with an external device over short range distances using ultra high frequency radio waves. In particular, the communication interface 160 may use a standard, such as Bluetooth. In other examples, the communication interface 160 may connect to an external device, such as a print server, via the Internet, or may connect via wireless or wired connections with other components or processor of the printing device.

The memory storage unit 165 is to store data and may include a non-transitory machine-readable storage medium that may be any electronic, magnetic, optical, or other physical storage device. The non-transitory machine-readable storage medium may include, for example, random access memory (RAM), electrically-erasable programmable read-only memory (EEPROM), flash memory, a storage drive, an optical disc, and the like. The memory storage unit 165 may also be encoded with executable instructions to operate the apparatus 10a. In other examples, it is to be appreciated that the memory storage unit 165 may be substituted with a cloud-based storage system.

The memory storage unit 165 may also store an operating system that is executable by the controller 100 to provide general functionality to the apparatus 10a, for example, functionality to support various applications such as a user interface to access various features of the apparatus 10a. Examples of operating systems include Windows™, macOS™, iOS™, Android™, Linux™′ and Unix™. The memory storage unit 165 may additionally store applications that are executable by the controller 100 to provide specific functionality to the apparatus 10a, such as those described herein.

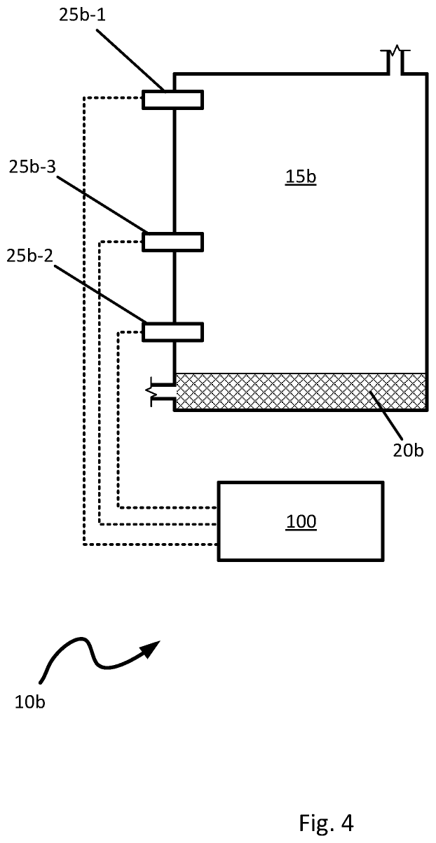

Referring to FIG. 4, another example of an apparatus to measure the mass of powder in a container is shown at 10b. Like components of the apparatus 10b bear like reference to their counterparts in the apparatus 10a, except followed by the suffix “b”. The apparatus 10b may be a part of the printing device or a separate component to operate on the printing device to estimate the amount of powder in a hopper of the printing device. The apparatus 10b includes a container 15b, a flow generator 20b, pressure sensors 25b-1, 25b-2, and 25b-3, and a controller 100.

In the present example, the apparatus 10b includes three pressure sensors 25b which may be used to measure pressure within the container 15b. Accordingly, in this example, the pressure sensors 25b are not specific to measuring pressure in the fluidized state or within a powder pack. Instead, the sensors 25b are operable across the entire range of pressures. It is to be appreciated that by using the same sensors for both the fluidized state measurements and the powder pack measurements, fewer components may be used. Although the present example includes three pressure sensors 25b, other examples may use more or less pressure sensors in the container 15b.

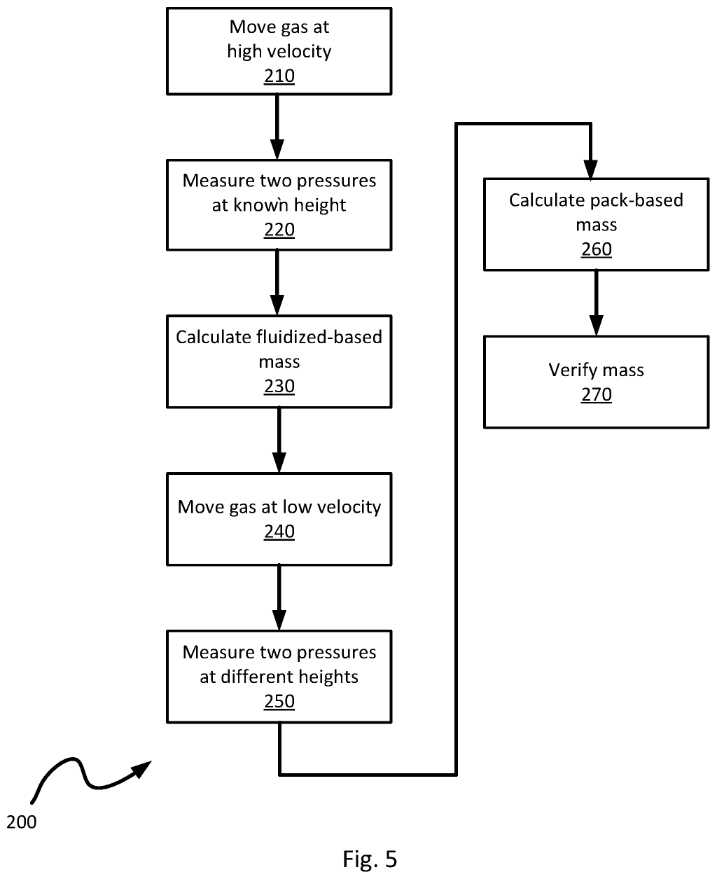

Referring to FIG. 5, a flowchart of a method of measuring the mass of powder in a container is shown at 200. In order to assist in the explanation of method 200, it will be assumed that method 200 may be performed with the apparatus 10a. Indeed, the method 200 may be one way in which apparatus 10a may be configured. Furthermore, the following discussion of method 200 may lead to a further understanding of the apparatus 10a and its various components. Furthermore, it is to be emphasized, that method 200 may not be performed in the exact sequence as shown, and various blocks may be performed in parallel rather than in sequence, or in a different sequence altogether.

Block 210 involves the flow generator 20a moving gas through a powder at a velocity to fluidize the powder in the container 15a. In the present example, this involves moving gas at a sufficiently high velocity to generate and maintain a fluidized state. The fluidized state means that the powder and gas mixture in the container 15a is to behave as fluid. It is to be appreciated that in order to achieve full fluidization, the container 15 is to have sufficient volume for the powder to mix with the gas in a fluid manner.

In block 220, the fluidized pressure sensor 25a-2 or the fluidized pressure sensor 25a-3 measures the pressure in the container 15a. In the present example, the pressure may be measured at either of the two fluidized pressure sensors 25a-2 and 25a-3 while using the fluidized pressure sensor 25a-1 to determine the gauge pressure. For example, the pressure may be measured at the fluidized pressure sensor 25a-1 positioned substantially near the top of the container 15a in the air space above the fluidized powder and the fluidized pressure sensors 25a-2 and 25a-3 are positioned within the fluidized powder of the container 15.

It is to be appreciated that once the measurement of the pressures has been completed, the powder in the container 15a may return to a packed bed state or an aerated state. Accordingly, block 210 and block 220 may be carried out relatively quickly, such as with a fluidization burst where the flow generator 20a moves the gas at high velocity only for a short period of time and that the fluidized state is to be maintained only temporarily.

Block 230 involves calculating the mass of the powder in the container 15a using the pressure data received at block 220. The data from two of the fluidized pressure sensors 25a may be used to determine a fluidized pressure differential between two different heights in the container 15a. It is to be appreciated that the pressure during full fluidization decreases at higher heights in the container 15a. In particular, the weight of the powder (i.e. the gravitational force applied by the powder) above the fluidized pressure sensor 25a-2 or the fluidized pressure sensor 25a-3 is the fluidized pressure differential between the the fluidized pressure sensor 25a-2 or the fluidized pressure sensor 25a-3 multiplied by the cross sectional area of the container 15a.

Block 240 involves the flow generator 20a moving gas through a powder at a velocity where the gas is to pass through the powder in a powder pack state. In this state, the velocity of the gas is sufficiently low such that the gas does not disturb the stationary powder in the powder pack.

In block 250, the pack pressure sensors 30a measure the pressure at two different heights in the container 15a. Next, block 260 involves calculating the mass of the powder in the container 15a using the pressure data received at block 220. The data from the pack pressure sensors 30a may be used to determine a pack pressure differential between two different heights in the container 15a. It is to be appreciated that the pressure in the powder pack decreases from the bottom of the powder pack to the top surface in a substantially linear manner. Furthermore, in the packed bed state, the gas flow through the powder pack is to be slow enough such that the powder pack is not lifted by the passage of the gas and each particle of the powder is static. Accordingly, by measuring the pressure at different heights, the height of the powder pack may be extrapolated assuming the linear decrease in gauge pressure to zero at the surface. Once the height of the powder pack is determined, the mass may be calculated based on the cross sectional area of the container 15a and the known density of the powder pack.

Block 270 involves verifying the actual mass of powder in the container using the calculated massed from block 230 and block 260. The values from the two calculation methods may then be compared with each other to determine if the difference is within a predetermined threshold. If the mass is verified, the method 200 may subsequently output the actual mass as the average of the values from block 230 and block 260. In other examples, one value may be selected over the other. If the mass is not verified, an error may be presented so that a user may intervene to make a decision. Accordingly, the method 200 may be used to reduce user intervention in the verification of the calculated mass during a build process.

It should be recognized that features and aspects of the various examples provided above may be combined into further examples that also fall within the scope of the present disclosure.

What is claimed is:

1. An apparatus comprising:
a container to store a powder;
a flow generator to move a gas to the container, wherein the flow generator is to move the gas at a first velocity and a second velocity, the first velocity to fluidize the powder in a fluidized state, and the second velocity to pass through stationary powder in a powder pack state;
a first fluidized pressure sensor to measure a first fluidized pressure in the container in the fluidized state maintained by the flow generator;
a second fluidized pressure sensor to measure a second fluidized pressure in the container in the fluidized state maintained by the flow generator;
a first pack pressure sensor to measure a first pack pressure in the container within a first height in a powder pack as the gas is passed through the powder in the powder pack state by the flow generator;
a second pack pressure sensor to measure a second pack pressure in the container within a second height in the powder pack as the gas is passed through the powder in the powder pack state by the flow generator; and
a measurement engine in communication with the first fluidized pressure sensor, the second fluidized pressure sensor, the first pack pressure sensor, and the second pack pressure sensor, wherein the measurement engine is to calculate a mass of the powder based on a fluidized pressure differential between the first fluidized pressure and the second fluidized pressure, and wherein the measurement engine is to calculate the mass of the powder based on a pack pressure differential between the first pack pressure and the second pack pressure.

2. The apparatus of claim 1, wherein the flow generator is to provide a fluidization burst to provide the fluidized state temporarily.

3. The apparatus of claim 2, further comprising a third fluidized pressure sensor to allow the measurement engine to calculate a density.

4. The apparatus of claim 3, wherein the measurement engine is to calculate the mass of the powder based on the fluidized pressure differential instantaneously upon receiving a confirmation of the fluidized state.

5. The apparatus of claim 1, wherein the flow generator is to provide an aeration burst to level the powder to form the powder pack.

6. The apparatus of claim 1, further comprising a selection engine to make a determination whether the mass is to be calculated via the fluidized state or via the stationary powder in the powder pack state.

7. The apparatus of claim 6, wherein the determination is based on a volume of the container.

8. The apparatus of claim 1, further comprising a verification engine to verify the mass calculated by the measurement engine.

9. The apparatus of claim 8, wherein the verification engine compares the mass calculated by the measurement engine via the fluidized state with the mass calculated via the stationary powder in the powder pack state.

10. A method comprising:
moving a gas through a powder at a first velocity, wherein the first velocity is to fluidize the powder;
measuring a first fluidized pressure at a first fluidized pressure sensor;
measuring a second fluidized pressure at a second fluidized pressure sensor, wherein the first fluidized pressure sensor and the second fluidized pressure sensor are disposed at different heights in a container;
calculating a fluidized-based mass of the powder based on a fluidized pressure differential between the first fluidized pressure and the second fluidized pressure;
moving the gas through the powder at a second velocity, wherein the second velocity is to flow through the powder without a disturbance in the powder;
measuring a first pack pressure at a first pack pressure sensor;
measuring a second pack pressure at a second pack pressure sensor, wherein the first pack pressure sensor and the second pack pressure sensor are disposed within a powder pack at different heights in the container;
calculating a packed bed mass of the powder based on a pack pressure differential between the first pack pressure and the second pack pressure; and
verifying a mass of the powder in the container via a comparison of the fluidized-based mass and the packed bed mass.

11. The method of claim 10, wherein verifying comprises determining whether the fluidized-based mass and the packed bed mass are within a predetermined threshold.

12. The method of claim 10, wherein moving the gas through the powder at the first velocity comprises providing a fluidization burst to provide a fluidized state temporarily.

13. A non-transitory machine-readable storage medium encoded with instructions executable by a processor of an electronic device to:
receive a first fluidized pressure from a first fluidized pressure sensor;
receive a second fluidized pressure from a second fluidized pressure sensor, wherein the first fluidized pressure sensor and the second fluidized pressure sensor are disposed at different heights in a container;
calculate a fluidized-based mass of a powder in the container based on a fluidized pressure differential between the first fluidized pressure and the second fluidized pressure;
receive a first pack pressure from a first pack pressure sensor;
receive a second pack pressure from a second pack pressure sensor, wherein the first pack pressure sensor and the second pack pressure sensor are disposed within a powder pack at different heights in the container;
calculate a packed bed mass of the powder based on a pack pressure differential between the first pack pressure and the second pack pressure; and
output a mass of the powder in the container, wherein the mass of the powder in the container is based on one of the fluidized-based mass or the packed bed mass.

14. The non-transitory machine-readable storage medium of claim 13, wherein the instructions when executed further cause the processor to verify the mass of the powder.

15. The non-transitory machine-readable storage medium of claim 14, wherein verification of the mass of the powder comprises determining whether the fluidized-based mass and the packed bed mass are within a predetermined threshold.
